(19) United States
(12) Patent Application Publication
(10) Pub. No.: US 2023/0358284 A1
(43) Pub. Date: Nov. 9, 2023

(54) FILTER HOUSING FOR BRAKE DUST PARTICLE FILTER FOR BRAKE DISC ARRANGEMENT

(71) Applicant: MANN+HUMMEL GmbH, Ludwigsburg (DE)

(72) Inventors: Macario Francisco DOS SANTOS ASCENSAO, Ludwigsburg (DE); Volker KUEMMERLING, Ludwigsburg (DE); Andreas PANNI, Ludwigsburg (DE)

(21) Appl. No.: 18/353,540

(22) Filed: Jul. 17, 2023

Related U.S. Application Data
(63) Continuation of application No. PCT/EP2022/050793, filed on Jan. 14, 2022.

(30) Foreign Application Priority Data
Feb. 5, 2021 (DE) 102021102775.6

(51) Int. Cl. F16D 65/00; B01D 46/00

(52) U.S. Cl. CPC F16D 65/0031; B01D 46/0002; B01D 2279/40

(57) ABSTRACT

A circular segment-shaped filter housing of a brake dust particle filter has first and second spaced-apart housing side walls delimiting between them a receiving space for a brake disc. The first housing side wall has a housing base wall and a support bridge adjoining the housing base wall in circumferential direction. The receiving space extends axially between the housing base wall of the first housing side wall and the second housing side wall. The second housing side wall extends only across an angle segment of the housing base wall of the first housing side wall. The support bridge has a circumferential end region facing away from the housing base wall and provided with at least one fastening point for connecting the support bridge to a brake caliper. The first housing side wall extends across a first housing side wall angle segment of at least 180°.

### CROSS-REFERENCE TO RELATED APPLICATIONS

This application is a continuation application of International Application No. PCT/EP2022/050793 filed on Jan. 14, 2022, which claims the benefit of German Application No. 102021102775.6 filed on Feb. 5, 2021, the entire disclosures of which are incorporated herein by reference for all purposes.

### BACKGROUND

The invention concerns a circular segment-shaped filter housing of a brake dust particle filter for a brake disc arrangement, the filter housing comprising two housing side walls spaced apart relative to each other and delimiting at least partially in sections a receiving space lying between the housing side walls for receiving a brake disc of the brake disc arrangement.

By means of brake dust particle filters which can be attached to brake disc arrangements, abraded brake particles can be caught which are produced during a braking event by the friction between brake disc and brake pad. The brake dust particle filter comprises a circular segment-shaped filter housing with a filter material received therein. The filter housing comprises two housing side walls which are spaced apart relative to each other, which are arranged at oppositely positioned sides of the brake disc in the mounted state and delimit an intermediately positioned receiving space for the brake disc. Such a brake dust particle filter is described, for example, in DE 10 2012 016 835 A1.

Moreover, it is known to arrange an additional separately embodied housing section in circumferential direction at the filter housing of the brake dust particle filter, which housing section is connectable to the filter housing. This arrangement is described in US 2007/0000740 A1. The additional housing section serves for influencing the air flow containing the brake dust and for collecting the brake dust.

### SUMMARY

It is the object of the invention to provide with simple constructive measures a stably constructed brake dust particle filter which, in particular in the mounted state, has a reduced tendency to excite vibrations.

This object is solved according to the invention in that a first housing side wall is comprised of a housing base wall and a support bridge adjoining in circumferential direction, wherein the receiving space extends axially between the housing base wall of the first housing side wall and the second housing side wall, and wherein the second housing side wall extends only across an angle segment of the housing base wall of the first housing side wall, and wherein the support bridge comprises in a circumferential end region facing away from the housing base wall at least one fastening point which is configured to connect the support bridge to a brake caliper of the brake disc arrangement, wherein the first housing side wall with the housing base wall and the support bridge extends across an angle segment of at least 180°.

The dependent claims provide expedient further embodiments.

Terms of directions such as axial, radial, and tangential are to be understood herein always in relation to a rotational direction of a brake disc of the brake disc arrangement in the mounted state of the filter housing according to the invention.

The filter housing according to the invention of the brake dust particle filter comprises a circular segment-shaped basic geometry and serves to catch brake dust in a brake disc arrangement used preferably in motor vehicles. The filter housing comprises two housing side walls which are arranged spaced apart relative to each other and delimit at least partially in sections an intermediately positioned receiving space into which the brake disc of the brake disc arrangement projects in the mounted state. The two housing side walls extend preferably parallel to each other and are connected at their radially outwardly positioned side by an exterior housing wall of the filter housing. Advantageously, both housing side walls and the radially outwardly positioned exterior housing wall are embodied as a one-piece component. In principle, a multi-part configuration is also conceivable however, in particular a two-part embodiment with a left and a right housing side wall, wherein the exterior housing wall can be divided and arranged at each housing side wall or connected completely to one of the housing side walls.

A first housing side wall is comprised of a housing base wall and a support bridge adjoining in circumferential direction. The second housing side wall extends preferably across a smaller angle segment than the first housing side wall. Thus, the first housing side wall, comprised of housing base wall and support bridge, covers a larger angle segment than the second housing side wall. Advantageously, the second housing side wall extends across the same angle segment as the housing base wall of the first housing side wall and is positioned immediately opposite the housing base wall. In other words, the support bridge extends in circumferential direction in particular to a point beyond the receiving space.

The receiving space extends in this context axially between the housing base wall of the first housing side wall and the second housing side wall.

This embodiment has the advantage that an additional fastening of the filter housing at the brake disc arrangement is possible by means of the support bridge. In particular, fastening at oppositely positioned sides of the filter housing in circumferential direction can be carried out at the brake disc arrangement. Fastening is realized advantageously at a brake caliper of the brake disc arrangement. For example, it is possible to realize a first fastening at the free front face of the first or of the second housing side wall and a further fastening at the oppositely positioned end in circumferential direction, at the free front face of the support bridge. There are therefore at least two fastening points at which the filter housing of the brake dust particle filter can be connected to the brake caliper of the brake disc arrangement. In this way, a better and more stable connection to the brake disc arrangement is provided which is stable over a long operating period and better withstands external effects such as oscillations, vibrations, or weather effects. As needed, the filter housing can be designed with thinner walls without this having a negative impact on the stability. Also, the flow conditions in the brake dust particle filter can be influenced by means of the support bridge. This concerns in particular the flow guidance of the air flow containing brake dust.

In embodiments, both housing side walls can comprise at a side facing the support bridge a radial or tangential end face, wherein the support bridge adjoins the radial or tangential end face of the housing base wall. Preferably, the radial or tangential end faces of the housing side walls are connected by an end wall. The end wall, in turn, can comprise a receiving slot through which the brake disc extends in a mounted state.

According to a further advantageous embodiment, a part of the support bridge is arranged to overlap in circumferential direction the housing base wall. In this embodiment, the housing base wall and the support bridge form separate components which however are advantageously fixedly connected to each other. The support bridge is positioned preferably at the inner side which is facing the receiving space, wherein, as needed, an arrangement with the support bridge at the exterior side of the housing base wall facing away from the interior is also conceivable. A circularly curved section of the support bridge can be displaced along the likewise circularly curved housing base wall until it reaches the desired final position and is fixed in this position. It may be expedient, as needed, that the support bridge as a whole extends across a larger angle segment than the housing base wall.

In embodiments, the support bridge can extend across an angle segment of at least 20°, preferably at least 40°.

In an advantageous embodiment, the housing base wall and the support bridge are designed as separate components which however are fixedly connected to each other. The support bridge and the housing base wall, as needed, can also form a common one-piece component. The transition from the circumferential end of the housing base wall to the support bridge can be clearly delimited, for example, in the form of a circumferential end face at the housing base wall. It is possible that the support bridge comprises a different cross section shape in comparison to the housing base wall.

According to a further advantageous embodiment, it is provided that the housing base wall of the first housing side wall and the second housing side wall are embodied approximately or completely mirror-symmetrically to each other. The housing base wall and the second housing side wall are positioned parallel displaced immediately opposite each other and extend across the same angle segment. The support bridge which adjoins the housing base wall projects in circumferential direction past this angle segment and expands correspondingly the angle segment of the housing base wall. Advantageously, the housing base wall extends across a larger angle segment than the support bridge. Alternatively, it is however also possible that the support bridge extends across the same angle segment as the housing base wall or across a larger angle segment. The housing base wall and the support bridge cover an angle segment of at least 180°.

The necessity of an additional support of the filter housing by a support bridge exists primarily in filter housings of brake dust filters which extend across a relatively large angle segment of the brake disc. Since an increased vibration tendency results in case of an only one-sided fastening of the filter housing at a component stationary in relation to the vehicle, the support bridge provided according to the invention is a surprisingly effective measure in order to significantly reduce the degree of vibration excitation. The problem of vibration excitation is negatively affected in addition by the mass of the filter housing so that the filter housing according to the invention is in particular suitable for brake dust particle filters which are provided for heavy commercial vehicles and/or rail vehicles. Such filter housings differ significantly from brake dust particle filter housings for use in passenger cars.

In case of a deviating design of the support bridge compared to the housing base wall, it can be expedient that the radially outwardly positioned exterior side of the support bridge is radially recessed at least in sections in relation to the outer radius of the housing base wall. The exterior side of the housing base wall extends preferably in a circular shape; in relation to this circular shape, the exterior side of the support bridge is radially recessed at least in sections.

The receiving space positioned between the housing base wall and the second housing side wall serves also for receiving a filter material at which the brake dust deposits. In contrast thereto, the part of the support bridge which is projecting past the housing base wall is advantageously free of filter material and serves only for additional fastening of the filter housing as well as for flow guiding, as needed.

The radially recessed exterior side of the support bridge comprises, for example, a straight section which can extend in particular tangentially (in relation to a rotational direction of the brake disc in the mounted state). It can be expedient that the exterior side of the support bridge is comprised of a first circularly curved section and a second straight section, wherein the circularly curved section adjoins immediately the circularly shaped housing base wall. This straight second section of the support bridge can be designed to taper in a pointed triangular shape.

The support bridge comprises an additional fastening point by means of which the fastening is realized preferably at the brake caliper of the brake disc arrangement. The fastening point is located in the circumferential end region of the support bridge facing away from the housing base wall, preferably in the region of a distal triangular tip.

According to yet another advantageous embodiment, the support bridge is provided with flow openings. The flow openings have a flow-influencing and flow-guiding function for the air flow in which the brake dust is entrained. Flow openings can be provided also in the housing base wall as well as in the second housing wall and in the connecting exterior housing wall positioned radially outwardly. As needed, the flow openings of the support bridge differ from the flow openings of the housing base wall. The flow openings in the housing base wall are designed, for example, in a slot shape and extend in tangential direction. The flow openings in the support bridge can be designed in a rectangular shape or trapezoidal shape, as needed, triangular.

The invention relates also to a brake dust particle filter which comprises an afore described circular segment-shaped filter housing including a support bridge. The brake dust particle filter contains in addition a filter material which is received in the receiving space which is located between the housing side walls and receives also the brake disc. The filter material can have a U-shaped cross section shape which engages across the brake disc.

A further aspect of the invention concerns a brake disc arrangement/brake dust particle filter combination with an afore described brake dust particle filter and with a brake disc arrangement, wherein the support bridge of the filter housing of the brake dust particle filter is fastened to a brake caliper of the brake disc arrangement.

### BRIEF DESCRIPTION OF DRAWINGS

Further advantages and expedient embodiments can be taken from the further claims, the figure description, and the drawings.

FIG. 1 shows a perspective view of a combination of brake disc arrangement and brake dust particle filter comprising a filter housing with a support bridge at a housing side wall.

FIG. 2 shows the combination of brake disc arrangement and brake dust particle filter in a further perspective view.

FIG. 3 shows the filter housing of the brake dust particle filter in a perspective corresponding to FIG. 1.

FIG. 4 shows the filter housing in a perspective corresponding to FIG. 2.

FIG. 5 shows the combination of brake disc arrangement and brake dust particle filter from a first perspective, wherein the brake disc arrangement is illustrated only partially.

FIG. 6 shows an illustration corresponding to FIG. 5 in side view.

FIG. 7 shows an illustration corresponding to FIG. 5 or FIG. 6 but in a view from the rear.

In the FIGURES, same components are provided with same reference characters.

### DETAILED DESCRIPTION

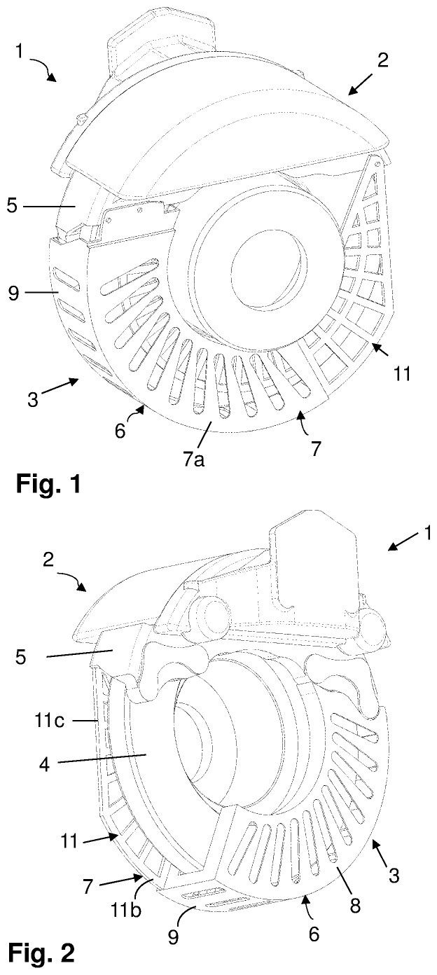

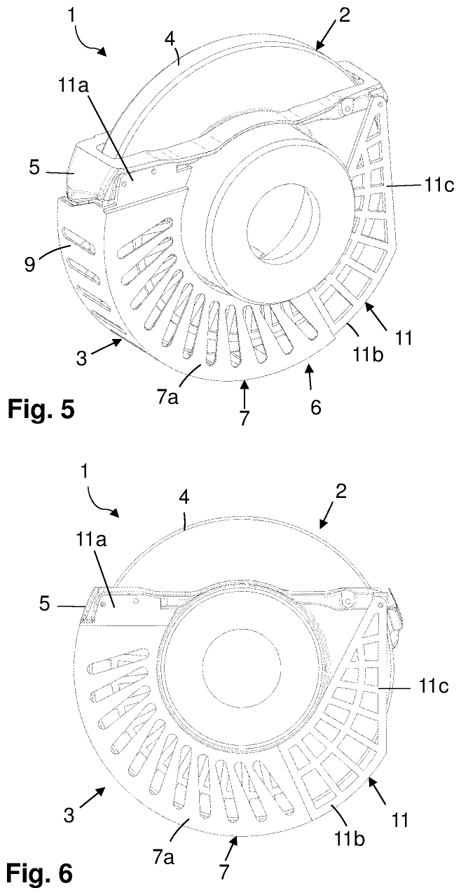

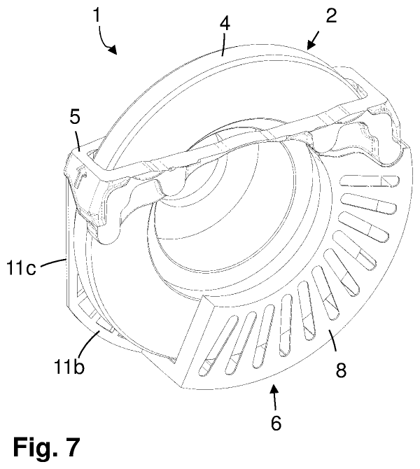

In FIGS. 1 and 2 as well as partially in FIGS. 5 to 7, a combination 1 of a brake disc arrangement 2 and of a brake dust particle filter 3, held and supported by the brake disc arrangement 2, is illustrated. The brake disc arrangement 2 is typically used in motor vehicles. The brake dust particle filter 3 absorbs the brake dust produced by abrasion of the brake pads when the brake disc arrangement 2 is actuated.

In addition to the brake disc 4, the brake disc arrangement 2 comprises a brake caliper 5 which is a carrier of brake pads which contact the brake disc 4 in a braking event. The brake caliper 5 is floatingly supported at a brake caliper holder which is fastened at a wheel support, for example. The floating support of the brake caliper 5 permits a relative movement of the brake caliper in relation to the brake caliper holder in axial direction, in relation to the longitudinal axis of the brake disc 4.

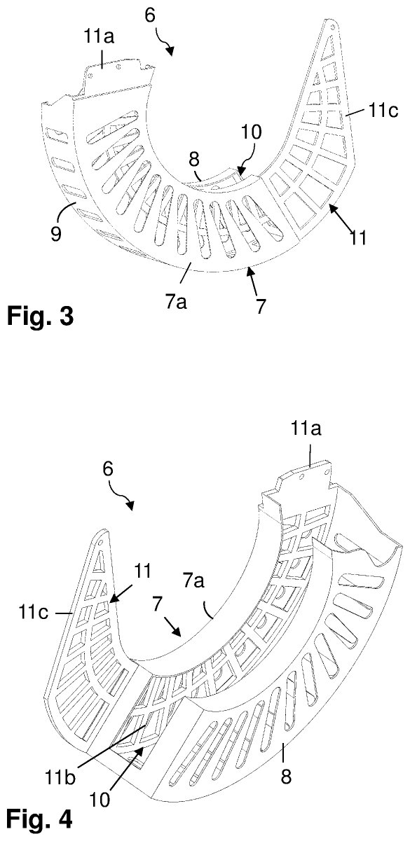

The brake dust particle filter 3 comprises a filter housing 6 in which a filter material is received at which the brake dust deposits. The filter housing 6, which is illustrated in detail in FIGS. 3 and 4, is of a circular segment-shaped configuration and comprises two spaced-apart housing side walls 7 and 8 arranged parallel to each other and connected by a radially outwardly positioned curved exterior housing wall 9. In both housing side walls 7, 8 and in the exterior housing wall 9, flow openings are provided through which the air, from which brake dust has been removed, can flow out. The housing side walls 7, 8 delimit between them a receiving space 10 for receiving the brake disc 4. The receiving space 10 comprises a U-shaped cross section shape. The filter material, inserted into the receiving space 10 and absorbing the brake dust, also comprises a U-shaped cross section shape, which makes it possible that the brake disc 4 projects into the receiving space 10.

The first housing wall 7 is comprised of a housing base wall 7a and a support bridge 11 which adjoins the housing base wall 7a in circumferential direction. The housing base wall 7a is substantially embodied mirror-symmetrically to the second housing side wall 8; they extend across the same angle segment which amounts to between 100° and 120°. The housing base wall 7a and the support bridge 11 extend in total across an angle segment of 180°. The housing base wall 7a, the housing wall 8, and the exterior housing wall 9 form a one-piece component. The support bridge 11 is designed as a separate component.

The support bridge 11 also comprises flow openings which however differ in regard to their shape from the flow openings in the housing base wall 7a and in the second housing wall 8. Flow openings in the housing base wall 7a and in the oppositely positioned second housing side wall 8 are of a slot-shaped embodiment and extend in tangential direction, while the flow openings in the support bridge 11 are embodied in a rectangular shape, in particular trapezoidal shape and partially in a triangular shape. The flow openings in the exterior housing wall 9 are also configured slot-shaped and extend in axial direction, in relation to the longitudinal and rotational axis of the brake disc 4.

As can be seen in particular in FIG. 4, the support bridge 11 extends across a larger angle segment than the housing base wall 7a. The support bridge 11 is embodied separate from the housing base wall 7a and rest against the inner side of the housing base wall 7a which is facing the receiving space 10.

The support bridge 11 is comprised of a total of three sections: of a fastening section 11a which is located at a circumferential end, a curved section 11b, and a triangular section 11c with a straight exterior side. The curved section 11b extends parallel to the housing base wall 7a while the fastening section 11a and the triangular section 11c project away from the housing base wall 7a at oppositely positioned sides. The fastening section 11a as well as the triangular section 11c serve for fastening at the brake caliper 5. For this purpose, fastening points are provided in the fastening section 11a and in the outwardly positioned tip of the triangular section 11c. The support bridge 11 thus makes it possible that the filter housing 6 is connected to the brake caliper at two oppositely positioned points in circumferential direction so that a connection with high stability is created.

The triangular section 11c is slanted in such a way at the straight exterior side that this straight exterior side is radially recessed in relation to the outer radius of the housing base wall 7a and the support bridge 11.

The support bridge 11 can be fastened at any side of the filter housing 6. In the embodiment, the support bridge 11 is located at the first housing side wall 7. However, an arrangement at the oppositely positioned second housing side wall 8 is possible also. The support bridge 11 can be arranged at the inner side as well as at the exterior side of the housing walls.

1. A circular segment-shaped filter housing of a brake dust particle filter for a brake disc arrangement, the filter housing comprising:
a first housing side wall and a second housing side wall spaced apart relative to each other and delimiting at least partially in sections a receiving space configured to receive a brake disc of the brake disc arrangement and lying between the first and the second housing side walls,
wherein the first housing side wall is comprised of a housing base wall and a support bridge adjoining the housing base wall in a circumferential direction of the filter housing,
wherein the receiving space extends axially between the housing base wall of the first housing side wall and the second housing side wall,
wherein the second housing side wall extends across a second housing side wall angle segment corresponding only to a housing base wall angle segment of the housing base wall of the first housing side wall,
wherein the support bridge comprises a circumferential end region facing away from the housing base wall,
wherein the support bridge comprises at least one fastening point arranged in the circumferential end region and configured to connect the support bridge to a brake caliper of the brake disc arrangement, and
wherein the first housing side wall, comprised of the housing base wall and the support bridge, extends across a first housing side wall angle segment of at least 180°.

2. The filter housing according to claim 1, wherein the second housing side wall angle segment of the second housing side wall is smaller than the first housing side wall angle segment of the first housing side wall.

3. The filter housing according to claim 1, wherein the support bridge extends to a point beyond the receiving space in the circumferential direction of the filter housing.

4. The filter housing according to claim 1, wherein the first and the second housing side walls each comprise a radial or tangential end face on a side facing the support bridge, and
wherein the support bridge adjoins the radial or tangential end face of the first housing side wall.

5. The filter housing according to claim 4, wherein the radial or tangential end face of the first housing side wall and the radial or tangential end face of the second housing side wall are connected to each other by an end wall.

6. The filter housing according to claim 1, wherein the housing base wall of the first housing side wall and the second housing side wall each comprise a radial or tangential end face on a side facing the support bridge, wherein the support bridge adjoins the radial or tangential end face of the housing base wall of the first housing side wall.

7. The filter housing according to claim 6, wherein the radial or tangential end face of the housing base wall of the first housing side wall and the radial or tangential end face of the second housing side wall are connected to each other by an end wall.

8. The filter housing according to claim 1, wherein the support bridge comprises a radial exterior side, wherein the radial exterior side of the support bridge is radially recessed, at least in sections, relative to an outer radius of the housing base wall.

9. The filter housing according claim 8, wherein a first section of the radial exterior side of the support bridge is circularly curved and a second section of the radial exterior side of the support bridge is straight.

10. The filter housing according claim 9, wherein a straight section extends tangentially.

11. The filter housing according to claim 5, wherein the support bridge comprises flow openings.

12. The filter housing according to claim 1, wherein the housing base wall and the second housing side wall are embodied approximately or completely mirror-symmetrically relative to each other.

13. The filter housing according to claim 1, wherein the housing base wall angle segment of the housing base wall is larger than a support bridge angle segment of the support bridge.

14. The filter housing according to claim 13, wherein the support bridge angle segment extends across at least 20°.

15. The filter housing according to claim 13, wherein the support bridge angle segment extends across at least 40°.

16. The filter housing according to claim 1, wherein the housing base wall and the support bridge of the first housing side wall are separate components, and
wherein the separate components are connected to each other.

17. The filter housing according to claim 16, wherein a part of the support bridge is arranged so as to overlap the housing base wall in the circumferential direction.

18. A brake dust particle filter comprising:
the circular segment-shaped filter housing according to claim 1; and
a filter material arranged in the filter housing.

19. A system comprising:
the brake dust particle filter comprising the circular segment-shaped filter housing according to claim 1 and a filter material arranged in the filter housing; and
the brake disc arrangement comprising the brake caliper,
wherein the support bridge is fastened at the brake caliper of the brake disc arrangement.
